(19) United States
(12) Patent Application Publication
(10) Pub. No.: US 2023/0371447 A1
(43) Pub. Date: Nov. 23, 2023

(54) HORTICULTURE AUTOMATION SYSTEMS, DEVICES, AND METHODS

(71) Applicant: Peak Roots, Inc., Sisters, OR (US)

(72) Inventors: Theodore M. Thul, Pheonix, AZ (US); Darrin M. Dow, Sisters, OR (US)

(21) Appl. No.: 18/321,734

(22) Filed: May 22, 2023

Related U.S. Application Data
(60) Provisional application No. 63/344,453, filed on May 20, 2022.

(51) Int. Cl. A01G 9/26; A01G 9/02; A01G 9/24

(52) U.S. Cl. CPC A01G 9/26; A01G 9/023; A01G 9/247; A01G 9/249

(57) ABSTRACT

Horticulture automation systems, devices, and methods are disclosed herein. In some embodiments, a horticulture automation system for indoor vertical farming can include a sensor input configured to receive sensor readings related to a horticulture environment, an internet of things (“IoT”) module operably coupled to the sensor input, power supply channels coupled to luminaire panels, and a power control unit that controls the transfer and distribution of the power from a power supply to the power supply channels. The IoT module can communicate the sensor readings to a database and receive instructions to manage the horticulture environment. The device can be attached to a vertical grow rack and/or near a grow deck.

### CROSS-REFERENCE TO RELATED APPLICATION(S)

The present application claims the benefit of U.S. Provisional Patent Application No. 63/344,453, filed May 20, 2022, which is incorporated herein by reference in its entirety.

### TECHNICAL FIELD

The present disclosure generally relates to indoor horticulture, including automation systems, devices, and methods for vertical farming.

### BACKGROUND

Indoor cultivation of crops is an expanding market as difficulties mount for outdoor cultivation. For example, unpredictability in weather and climate has made outdoor cultivation increasingly difficult as drought and storms starve or drown crops. Even mild unpredictability in weather and climate short of drought or storms has inhibited proper growth of certain crops requiring specific growing conditions. Further, outdoor cultivation is limited by the changing of seasons and location of the cultivation site, creating difficulties when attempting to grow crops to meet consumer demands in certain regions or by requiring extensive supply chains.

In addition, the market for indoor cultivation is further expanding given the efficiencies and predictability it can provide. For example, indoor cultivation can limit the impact of unpredictable weather, reduce the reliance on seasons and/or geographic regions, and increase the variety and viability of the plant selection pool. Despite growth and advantages of indoor cultivation, the indoor environment provides its own unique challenges and the equipment used to facilitate and manage it has not kept pace.

### BRIEF DESCRIPTION OF THE DRAWINGS

Many aspects of the present disclosure can be better understood with reference to the drawings in the following Detailed Description. The components in the drawings are not necessarily to scale. Instead, emphasis is placed on clearly illustrating the principles of the present technology. Reference numbers/indicators are used consistently throughout the drawings and description for ease to refer to items having similar structure, features, and/or functions. Identical reference numbers/indicators are not indicative that the items are identical.

FIG. 1 is a partially schematic block diagram illustrating an overview of an environment in which some embodiments of a horticulture automation device can operate.

FIG. 2 is a partially schematic front view of a horticulture automation device configured in accordance with embodiments of the present technology.

FIG. 3 is a block diagram illustrating circuitry of a horticulture automation device configured in accordance with embodiments of the present technology.

FIG. 4 is a side view of a horticulture grow rack system configured in accordance with embodiments of the present technology.

FIGS. 5A and 5B are illustrations of displays showing data with a horticulture automation system in accordance with embodiments of the present technology.

FIG. 5C is an illustration of a display showing an automation protocol for a horticulture automation system in accordance with embodiments of the present technology

FIG. 6 is a front view of a luminaire panel assembly installed on a horticulture grow rack system in accordance with embodiments of the present technology.

FIG. 7A is an isometric top view of a luminaire panel system for a top layer of a horticulture grow rack system in accordance with embodiments of the present technology.

FIG. 7B is an isometric bottom view of luminaire panel system for an intermediate layer of a horticulture grow rack system in accordance with embodiments of the present technology.

FIG. 8 is an isometric view of a horticulture grow rack system for luminaire panel assemblies configured in accordance with embodiments of the present technology.

### DETAILED DESCRIPTION

The present disclosure is directed generally to horticulture automation systems (“automation systems”) and associated devices and methods for indoor cultivation and growth of organic products. Organic products can include, for example, consumable crops, such as fruits, vegetables, grains, and tubers; medicinal crops; flowers; saplings; and/or any other similar plant and/or organic product suitable for indoor cultivation. The horticulture automation systems of the present technology may include features for monitoring and controlling the physical environment of indoor farming to enhance plant cultivation and management. For example, horticulture automation devices (also referred to as “Smart Drops”) disclosed herein can monitor the environment during growth of organic products for indoor and outdoor cultivation and use this information to control horticulture devices to modify the environment in a manner that enhances or optimizes the growth of various organic products.

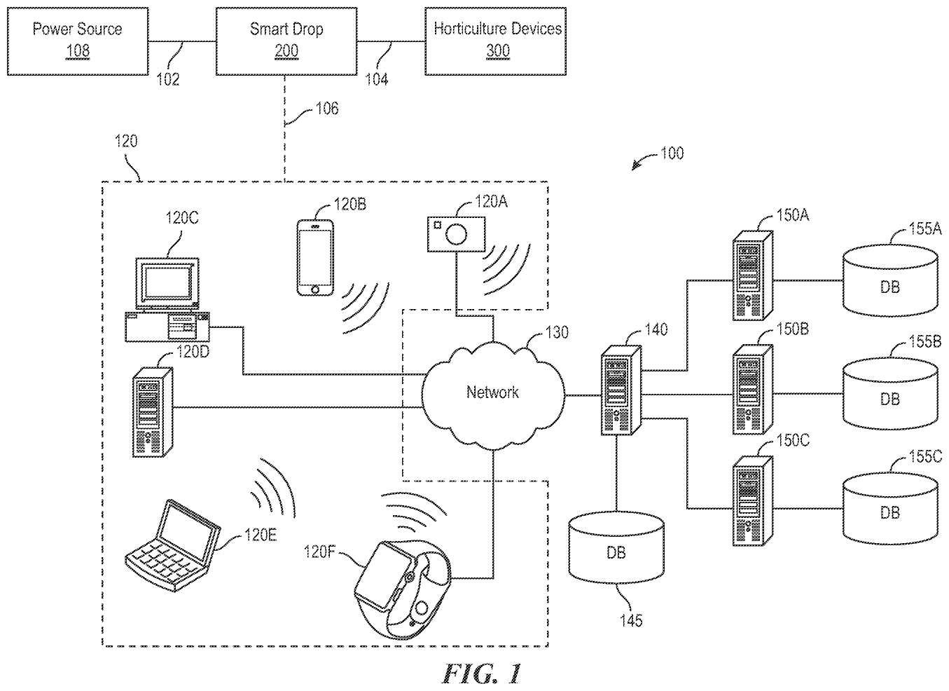

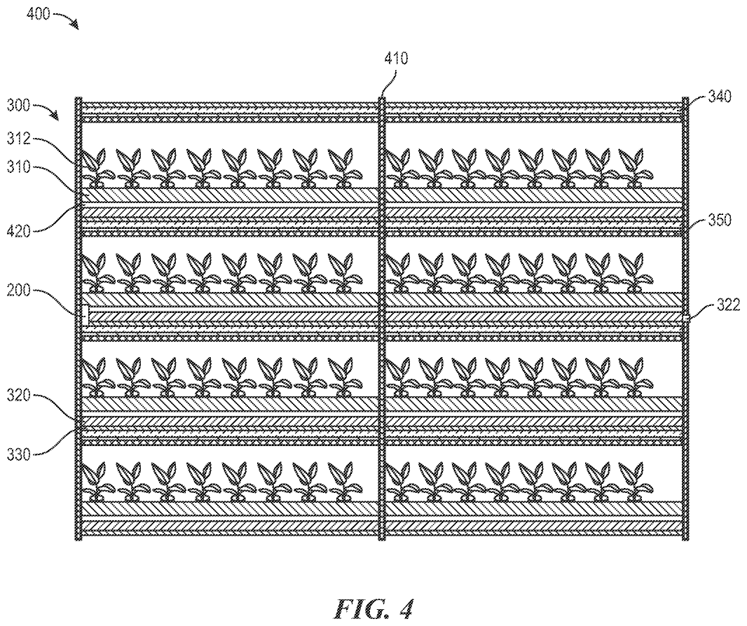

Specific details of several embodiments of the present technology are described herein with reference to FIGS. 1-8. Although many of the embodiments are described with respect to systems, devices, and methods for horticulture and indoor/outdoor cultivation applications, other applications and other embodiments in addition to those described herein are within the scope of the present technology. For example, at least some embodiments of the present technology may include and/or be operably connected to multiple sensors that detect and/or are used to determine near real time environmental, lighting, plant feeding metrics, or other similar characteristics. The horticulture automation devices can then use this data to enhance or optimize the growth environment. The end user can control and monitor various devices, via the horticulture automation devices, such as lights, pumps (monitored for line clogs via power consumption out of norm), valves, fans, heaters, chillers, lighting, power, visual cameras, thermal cameras, moisture sensor, pH sensor, electrical conductivity (EC) sensor, temperature sensors, integrated grow decks (as further described below with respect to FIG. 4), etc.

The horticulture automation device can be or include an Internet of Things (IoT) device that can be connected to and powered by a Power over Ethernet (PoE) switch. The device can then be connected to the cloud via any Internet Service Provider (ISP) that a client uses. The data from the horticulture automation device can be continuously fed to the cloud and/or other storage database, and various reports, metrics, alerts, and/or other business tools can be generated on demand in order to enhance or optimize the growth of organic products. The data collected can be used in aggregate to continuously create optimized recipes for the production of organic products. These recipes can be specific to the type of organic product, as well as reactive to the detected data of the growth environment. All of the technology can be (i) fully manual with reporting and alerting only, (ii) semi auto and can include the activating of pumps, lights, valves etc. as the customer sees fit, or (iii) a fully automated system that can take care of all of the functions in an automated way.

FIG. 1 is a block diagram illustrating an overview of an environment 100 in which some embodiments of a horticulture automation device 200 (“Smart Drop 200”) can operate. The horticulture automation device 200 can be electrically coupled to a power source or power supply 108 to receive power via connection 102 (e.g., a wire). In some embodiments, the horticulture automation device 200 is coupled to the power source 108 via a rectifier rack configured to convert alternating current (AC) to direct current (DC). In some embodiments, multiple horticulture automation devices 200 can each be connected to the same rectifier rack. For example, a 24 kW rectifier rack may include eight output channels, each channel outputting 3 kW and coupled to a horticulture automation device 200. In other embodiments, the horticulture automation device 200 can be connected to the power source 108 via different suitable configurations.

The horticulture automation device can also be operatively coupled to one or more horticulture devices 300 via connection 104. In some embodiments, the horticulture devices 300 can include any suitable equipment for managing and or controlling the horticulture environment in an indoor cultivation setting, such as luminaire panels, pumps, valves, fans, heaters, chillers, other lighting, irrigation equipment, fertilization equipment, and other similar equipment. In some embodiments, the horticulture devices 300 can also include sensors for monitoring the horticulture growth environment, such as visual cameras, thermal cameras, moisture sensors, pH sensors, electrical conductivity (EC) sensors, temperature sensors, and other sensors that can detect and/or be used to determine near real-time environmental, lighting, plant feeding metrics, or other similar characteristics. As will be described in further detail below with respect to FIG. 4, the horticulture automation device 200 and/or the horticulture devices can be included in integrated grow decks. The connection 104 between the horticulture automation device 200 and the horticulture devices 300 can be wired or wireless (e.g., data communicated over the Internet, Bluetooth, etc.). The connection 104 can allow data flow in both directions such that, for example, the horticulture automation device 200 can receive sensor data from sensors included among the horticulture devices 300 and then use the collected sensor data to control the devices for managing the horticulture environment included among the horticulture devices 300.

The horticulture automation device 200 can communicate, via a wired or wireless communication link 106, with one or more client computing devices 120, examples of which include an imaging device 120A, a smart phone or tablet 120B, a desktop computer 120C, a computer system 120D, a laptop computer 120E, and a wearable device 120F. These are only examples of some of the devices, and other embodiments can include other computing devices. Client computing devices 120 can collect various instructions or requests from a user (e.g., instructions on how to manage the horticulture environment, requests for a historical log of horticulture device activity). The user can control and monitor the horticulture environment anytime and/or remotely through the use of the client computing devices 120. Client computer devices 120 can operate in a networked environment using logical connections through network 130 to one or more remote computers, such as a server computing device. The networked environment can also be used to provide software updates to algorithms used to manage the horticulture automation device 200 and/or the one or more client computing devices 120. In some embodiments, the server 140 can be an edge server which receives client requests and coordinates fulfillment of those requests through other servers, such as servers 150A-C. Server computing devices 140 and 150 can include computing systems. Though each server computing device 140 and 150 is displayed logically as a single server, server computing devices can each be a distributed computing environment encompassing multiple computing devices located at the same or at geographically disparate physical locations. In some implementations, each server 150 corresponds to a group of servers.

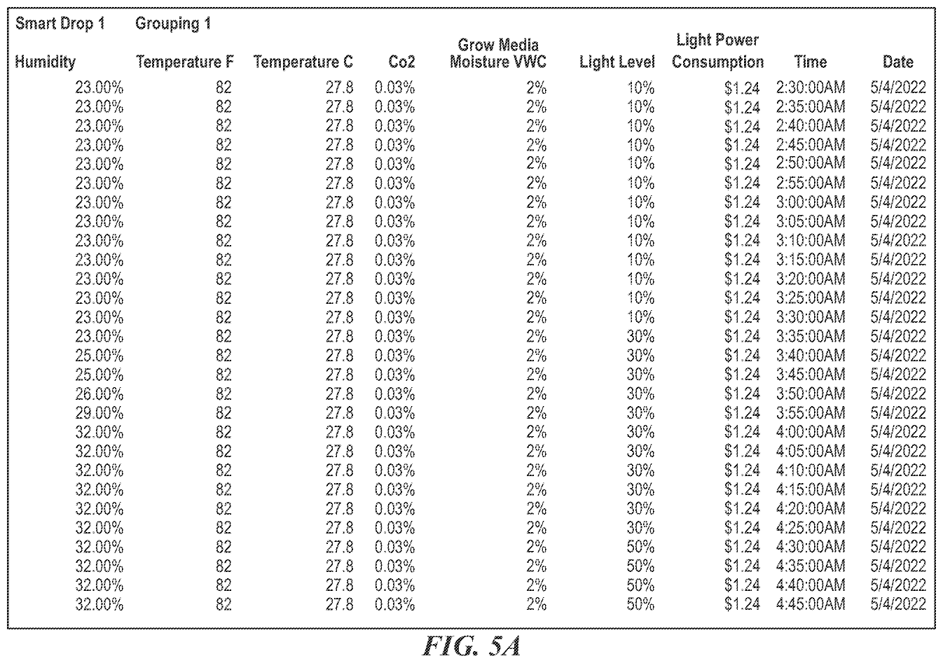

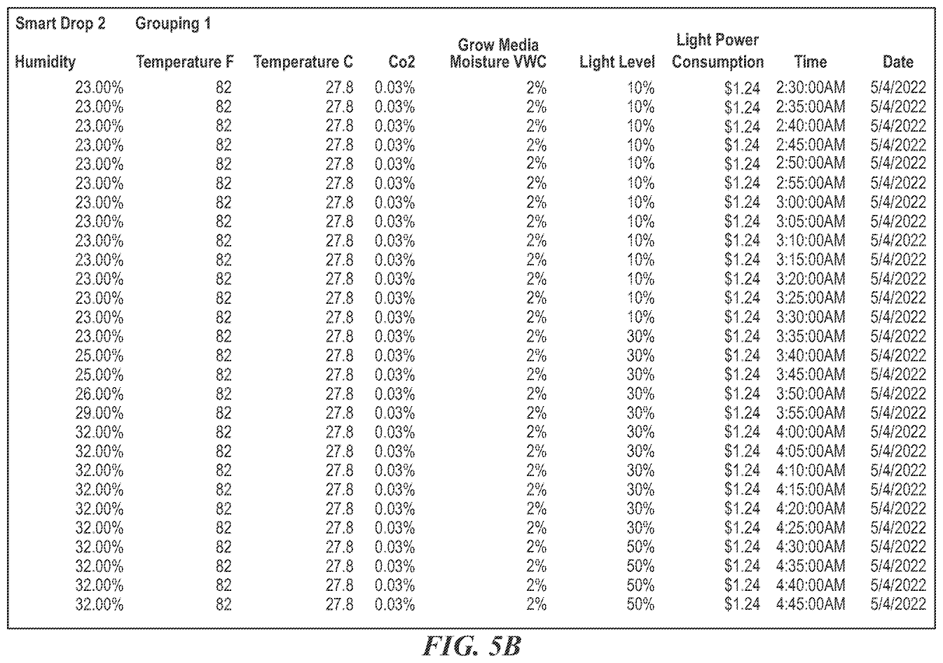

Client computing devices 120 and server computing devices 140 and 150 can each act as a server or client to other server/client devices. Server 140 can connect to a database 145. Servers 150A-C can each connect to a corresponding database 155A-C. As discussed above, each server 150 can correspond to a group of servers, and each of these servers can share a database or can have their own database. Databases 145 and 155 can warehouse (e.g., store) information. As will be discussed in further detail below with respect to FIGS. 4 and 5, databases 145 and 155 can store various sensor readings from the horticulture devices 300, historical activity logs of the horticulture devices 300, recipes for managing certain horticulture environments, etc. In some embodiments, databases 145 and 155 can serve as a backup system for storing information collected by the horticulture devices 300. Databases 145 and 155 can also be used to generate new data, such as cost reports associated with managing the horticulture environment. Though databases 145 and 155 are displayed logically as single units, databases 145 and 155 can each be a distributed computing environment encompassing multiple computing devices, can be located within their corresponding server, or can be located at the same or at geographically disparate physical locations.

Network 130 can be a local area network (LAN) or a wide area network (WAN), but can also be other wired or wireless networks. Portions of network 130 may be the Internet or some other public or private network. Client computing devices 120 can be connected to network 130 through a network interface, such as by wired or wireless communication. While the connections between server 140 and servers 150 are shown as separate connections, these connections can be any kind of local, wide area, wired, or wireless network, including network 130 or a separate public or private network.

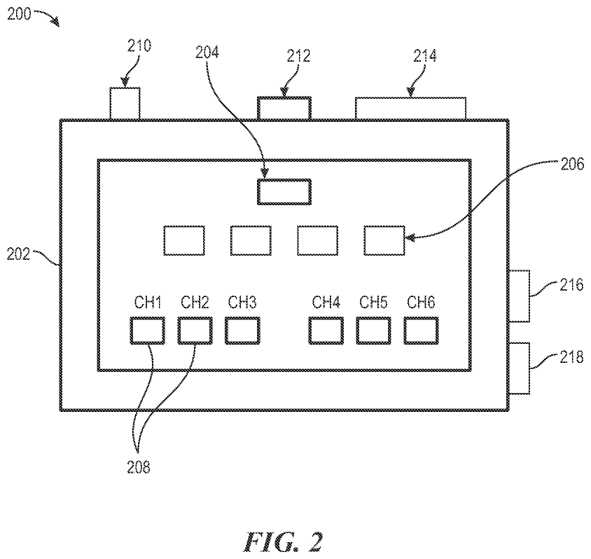

FIG. 2 is a partially schematic front view of the horticulture automation device 200 configured in accordance with embodiments of the present technology. The horticulture automation device 200 has an enclosure or housing 202 that can house or otherwise carry various circuitry and, optionally, protect such circuitry from moisture, chemicals, tampering, etc. The housing 202 can include a power switch 204 and/or various controls 206 for operating the horticulture automation device 200. Coupled to the housing 202 is a power input 212 that allows for various direct current voltages (e.g., 10 VDC, 100 VDC, 250 VDC, 500 VDC, 1000 VDC) to be applied. As discussed above with respect to FIG. 1, the power input 212 can be coupled to a power source through a rectifier or other device configured to convert AC to DC. In some embodiments, the rectifier or other device configured to convert AC to DC is positioned external to or far away from the horticulture environment (e.g., in a separate room) to minimize the impact of heat from the device to the organic products being grown and/or the moisture from the horticulture environment from impacting the power source. Also coupled to the housing is a network connection port 210 that can provide a data connection for communication with a network (e.g., the network 130 illustrated in FIG. 1) and/or power various circuitry (e.g., housed in the housing 202) by utilizing, for example, a power over ethernet (“PoE”) connection or switch.

The horticulture automation device 200 can transfer, split, and/or distribute the power received via the power input 212 into six individual power supply channels 208. For example, the power can be distributed evenly across the channels 208 and/or selectively applied at differing voltages across individual channels 208. In other embodiments, the horticulture automation device 200 can include fewer or more channels 208 (e.g., 1 channel, 10 channels, 100 channels, 1000 channels). In some embodiments, each channel 208 can provide 240 V outputs with a max current of 12 A. In other embodiments, the channels 208 can provide other voltage and/or current values depending on the power requirements of the horticulture device 300 connected to the channels 208. One or more horticulture devices 300 for managing or controlling the horticulture environment (e.g., luminaire panels) can be connected to and controlled together or individually via the channels 208. The horticulture automation device 200 can also include first and second input/output (I/O) connectors 216 and 218 for coupling to and controlling one or more horticulture devices 300 (e.g., pumps, fans, sensors). In the illustrated embodiment, the horticulture automation device 200 further includes power output 214, which may also be connected to one or more horticulture devices 300.

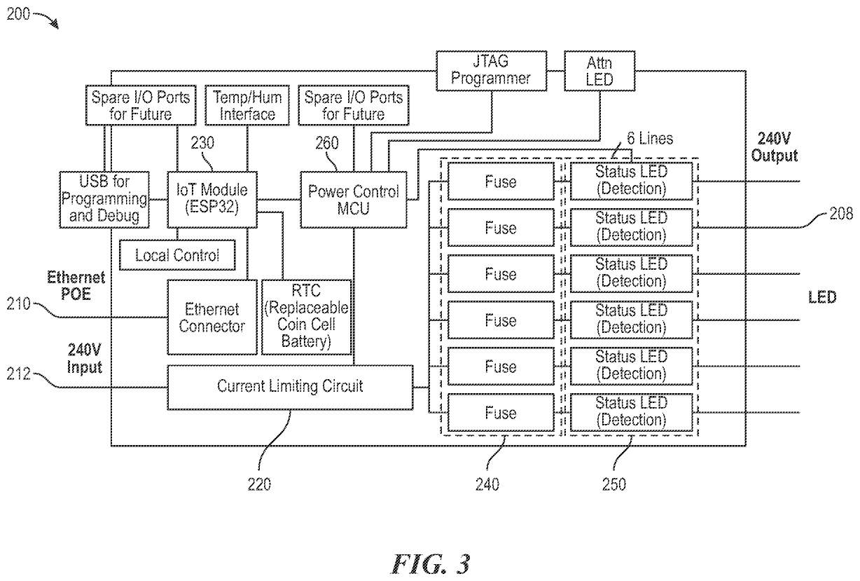

FIG. 3 is a schematic block diagram illustrating circuitry of the horticulture automation device 200 configured in accordance with embodiments of the present technology. As illustrated in FIG. 3, the horticulture automation device 200 can include multiple electronic components for monitoring and controlling one or more horticulture devices 300, as well as the horticulture environment surrounding the horticulture devices 300. Further, the multiple electronic components can allow for sharing monitored characteristics as well as receiving and sharing control instructions with networks external to the horticulture automation device 200. The horticulture automation device can monitor, or be connected to sensors monitoring, for example, temperature and air humidity, carbon dioxide level, wind speed and direction, precipitation, pest control, sterilization systems, chemical disinfection, UV sterilization, ozone sanitation, oxygen, HVAC integration, soil moisture, soil pH, electrical conductivity, water temperature, nutrient concentration (e.g., PPM), emitter clogging, water chillers, lighting, image processing for evaluating plants' health and maturity, or similar characteristics.

In the illustrated embodiment, the horticulture automation device 200 includes an IoT module 230 (e.g., ESP32) operatively coupled to receive data and/or power from an ethernet connector receiving a PoE connection through the network connection port 210. The IoT module 230 can include a universal serial bus (USB) port for programming and debugging, I/O ports for connecting to various systems and/or devices (e.g., varying numbers of network input port, such as ethernet ports, and network output ports), a temperature and humidity monitoring interface, and/or additional interfaces and/or communication ports. The IoT module 230 can also be coupled to a local controller, a power source (e.g., a replaceable coin cell battery), and a power control unit 260 (e.g., a microcontroller). The power control unit 260 can include I/O ports for connecting to various systems and/or devices, and can be coupled to a programming interface (e.g., JTAG interface) and an LED for indicating, for example, a status of the power control unit 260. The power control unit 260 can be operatively coupled to a current limiting circuit 220, which is coupled to one or more horticulture devices 300 (e.g., LED lighting) through the channels 208. In some embodiments, for example, each of the channels 208 is operably coupled to a luminaire panel assembly comprised of one or more luminaire panels (e.g., including an array LEDs) connected in series or in parallel, such the luminaire panels and systems disclosed in U.S. patent application Ser. No. 18/318,706 filed May 16, 2023, which is incorporated herein in its entirety. In some embodiments, the channels 208 can provide 240 V outputs with a max current of 12 A, or other suitable voltage and/or current values. The horticulture automation device 200 can further include a plurality of fuses 240 and a plurality of status LEDs 250. In the illustrated embodiment, one fuse 240 and one status LED 250 is coupled between the current limiting circuit 220 and one of the channels 208. In other embodiments, the fuses 240 and the status LEDs 250 may be arranged differently, or the horticulture automation device 200 may not include the fuses 240 and/or the status LEDs 250. The power control unit 260 can be coupled to individually control each status LED 250.

In operation, the IoT module 230 can monitor the horticulture environment using the sensor data received from the horticulture devices 300 and/or other inputs. The IoT module 230 can then instruct the power control unit 260 to operate the horticulture devices 300 to modify the horticulture environment to achieve desired outcomes for organic products under or adjacent to the horticulture devices 300. The power control unit 260, based on instructions provided by the IoT module 230, can operate the current limiting circuit 220 to direct electricity to the horticulture devices 300. The fuses 240 and the status LEDs 250 can protect and indicate the status (e.g., “on,” “off,” “error”) of, respectively, the horticulture devices 300 coupled to the channels 208.

FIG. 4 is a side view of a horticulture grow rack system 400 (also referred to as a a vertical grow rack) configured in accordance with embodiments of the present technology. The horticulture grow rack system 400 can include a rack assembly with vertical beams 410 (also referred to as vertical supports) and, optionally, horizontal beams or racks 420 coupled to the vertical beams 410 that support growing organic crops 312 in a vertical arrangement on multiple different levels. Each level can include a grow tray 310 which provides a vessel in which the crops 312 are grown and one or more horticultural devices 300 that support the growth of organic crops 312. For example, the horticultural devices can include an irrigation system 320 (also referred to as an irrigation component), sensors 330, an air flow system 340, and/or a lighting fixture 350 in a stacked arrangement. The horticulture grow rack system 400 is designed for vertical indoor farming and can include at least one of the horticulture automation device 200 described above with respect to FIGS. 2 and 3 mounted to a portion of the vertical grow rack system 440 (e.g., on the support beams 410, 420) and/or to a component thereof. The horticulture automation device 200 can collect inputs from and/or providing outputs to the horticulture devices 300 included in the horticulture grow rack system 400, such as sensors, luminaire panels, irrigation systems, fertilization systems, HVAC systems, and the like. The horticulture automation device 200 can also bring the power distribution (e.g., to luminaire panels and/or other devices) to the grow rack itself, rather than having power distribution and controls at a remote site (e.g., in a separate room) to provide a highly customized device control and to facilitate install.

The vertical and/or horizontal beams 410, 420 can support or otherwise carry grow trays 310 in which the crops 312 are grown, as well as the horticultural devices 300. For example, the grow tray 310 can be supported by the horizontal beams 420, vertical beams 310, and/or other cross beams (e.g., resting on top, coupled via fasteners). The one or more horticulture devices 300 can be mounted onto the vertical beams 410, the horizontal beams 420, and/or cross-members via fasteners and/or other attachment mechanisms. In the illustrated example, each horticulture device 300 defines a layer below or above a horizontal beam 420. In some embodiments, the device layers can be stacked in a different order than shown herein. Further, in some embodiments, portions of the device layers can be combined, omitted, and/or intermixed (e.g., the grow tray 310 can include portions of the sensors 330, etc.). In some embodiments, the horticulture devices 300 can include other devices for managing the horticulture environment (e.g., sterilization systems).

In some embodiments, the horticultural devices 300 can be integrated into a modular component (referred to as a deck system) that is mounted as a unit to the rack assembly at each level to provide for quick installation of a plurality of components for vertical farming. For example, a deck system for an intermediate level of the rack assembly can include the grow tray 310 integrated with the irrigation system 320, the air flow system 340, and the lighting fixture 350 such that the irrigation system 320 and/or air flow system 340 can support the overlying grow tray 310 and the lighting fixture 350 can provide light to the grow tray on the level below. The sensors 330 can also be integrated and provide monitoring and feedback related to the systems (e.g., the lighting, irrigation, and/or air flow systems) and/or characteristics of the grow environment for the under or overlying grow deck 310. In some embodiments, the grow tray 310 is omitted, and the deck system is installed on the underside of the grow tray 310 (e.g., attached to cross members and/or a shelf) to support the overlying grow tray 310 as well as provide light and other features to the underlying grow tray 310. In some embodiments, such as when the deck system is used at the top level of the grow rack system 400, the deck can include a subset of components (e.g., lighting, ventilation, sensors) to support the underlying grow tray 310 on the level below. The integrated unit of the deck system can provide a modular solution that can be installed at each level of the vertical grow rack system 400, thereby easing installation.

In some embodiments, the grow tray 310 can be a containment vessel in which the one or more organic products 312 (e.g., plants) are set (e.g., planted) in for growing, and can contain and route excess materials (e.g., water, soil, fertilizer, etc.) not used by the organic products away from the organic products. The grow tray 310 can have various connectors and ports that can be opened or closed to provide air flow and irrigation to the organic products and can act as drain ports. The grow tray 310 can also have ports for sensors to be embedded in, for example, the soil.

The irrigation system 320 can include channels, tubes, valves, pumps, and/or connectors, some or all of which may be contained within the integrated grow deck and are fed water, fertilizer, and/or other irrigation materials from an external source via an irrigation charging port 322. The irrigation system 320 can provide such irrigation materials to the grow tray 310 through ports included in the grow tray 310.

The sensors 330 can include sensors for monitoring air humidity, carbon dioxide level, wind speed and direction, precipitation, pest control, sterilization systems, chemical disinfection, UV sterilization, ozone sanitation, oxygen, HVAC integration, soil temperature, soil moisture, soil pH, electrical conductivity, water temperature, nutrient concentration (e.g., PPM), emitter clogging, water chillers, lighting, image processing for evaluating plants' health and maturity, and/or similar characteristics relating to the horticulture environment. The sensors can be coupled to the grow tray 310 through ports included in the grow tray 310. In some embodiments, the sensors 330 can include an internal irrigation volume measurement device that can activate (e.g., turn on or off) pumps external to the irrigation system 403, or open or close valves, providing irrigation to the irrigation system 403.

The air flow system 340 can include air flow ducting, fans, and/or other air flow components to provide air flow and/or otherwise deliver air to the crops 312 of the grow tray 310. In some embodiments, the air flow system 340 can be fluidly coupled to ports included in the grow tray 310.

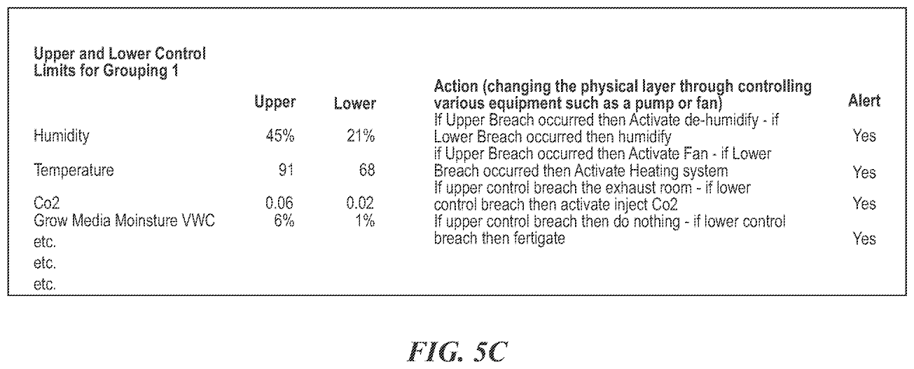

The lighting fixtures 350 can be luminaire panel assemblies that include lighting panels (e.g., LED arrays) for providing light to facilitate growth of the crops 312. In some embodiments, the lighting fixture 350 can include the lighting panel systems described below with respect to FIGS. 6-8.

In some embodiments, the horticulture grow rack system 400 includes one or more horticulture automation devices 200, which can be coupled to the vertical beams 410, the horizontal beams or racks 420, the horticulture devices 300, and/or positioned in another suitable location. As described with respect to FIGS. 1-3, the horticulture automation devices 200 can be electrically and/or operatively coupled to the various horticulture devices 300 in order to monitor and manage the horticulture environment. In some embodiments, individual ones or groups of the horticulture automation devices 200 can be associated with one or more layers or units of the horticulture environment. For example, a first grouping of horticulture automation devices 200 can be associated with the left side of the illustrated horticulture grow rack system 400 and a second grouping of horticulture automation devices 200 can be associated with the right side of the illustrated horticulture grow rack system 400. The association between horticulture automation devices 200 and different units of the horticulture environment can improve the monitoring and managing of the horticulture environment, such as by interpreting various sensor readings in the aggregate and optimizing different units of the horticulture environment individually.

The horticulture grow rack system 400 can include some or all of the hardware needed for indoor growth systems into a horizontally and/or vertically arranged deck. The valuable grow deck real estate is where individual components from vendors (e.g., lighting, air flow, fertigation, sensors, and environmental controls) can be located. By engineering a complete system, and in some embodiments including automation of individual components, the integrated grow deck system can reduce the real estate taken up by the individual components and allow for increased scaling. Further, the integrated components of each deck system for each level of the vertical grow deck allows for an easy to install on existing vertical grow racks, and provides a modular, plug-and-play system in which each level can be installed as a unitary, either including the grow tray 310 or without.

FIGS. 5A-C are illustrations of displays showing data and algorithms associated with a horticulture automation system in accordance with embodiments of the present technology. In some embodiments, the displays can be associated with the horticulture automation device 200 and/or the horticulture grow rack system 400 discussed above.

FIGS. 5A and 5B each show a log of various sensor measurements, in tabular form, corresponding to a first horticulture automation device (“Smart Drop”) and a second horticulture automation device in a same grouping (“Grouping 1”), respectively. In the illustrated embodiments, the log includes humidity, temperature, CO2 level, grow media moisture volumetric water content (VWC), light level, and light power consumption readings in 5-minute increments. In other embodiments, fewer, more, and/or other sensor readings can be displayed at different time increments (e.g., every 30 minutes, every hour, etc.).

In some embodiments, the real-time data can be accessed via the client computing devices 120 (FIG. 1), which may incorporate webhooks and/or APIs, and the log can update in real-time. In some embodiments, a user can request a historical log of the data through any specified time period (e.g., the past 6 hours) and/or with selected sensor readings (e.g., showing humidity data but not temperature data). In some embodiments, the data can be used to generate various business tools such as cost reports (e.g., including cost of powering the lighting units, cost of fertigation materials, etc.).

FIG. 5C shows an example algorithm for monitoring and managing the horticulture environment unit associated with Grouping 1. In the illustrated embodiment, the algorithm compares current sensor readings against upper and lower thresholds corresponding to each sensor reading. In some embodiments, the upper and lower thresholds can be determined or adjusted by the user. In some embodiments, the upper and lower thresholds are predetermined according to a horticulture recipe stored in a database (e.g., databases 145 and 155 in FIG. 1). In some embodiments, the horticulture recipe can be specific to the type(s) of crop being grown in the particular grouping.

The algorithm can further include predetermined actions for when a current sensor reading breaches either the upper or lower threshold. For example, in the illustrated embodiment, if the temperature reading reaches or exceeds 91 degrees Fahrenheit, the algorithm can instruct the horticulture automation devices associated with Grouping 1 to activate a fan included among the horticulture devices 300. If the temperature reaches or drops below 68 degrees Fahrenheit, the algorithm can instruct the horticulture automation devices associated with Grouping 1 to activate a heating system included among the horticulture devices 300. In another example, if the sensors determine that the crops need to be watered or irrigated, the algorithm can instruct the horticulture automation devices to pump a specified volume of water into the soil, pump water until a certain coil moisture level is detected, etc.

In some embodiments, the sensor reading compared against the upper and lower thresholds can be an average of multiple sensor readings associated with different horticulture automation devices 200. In some embodiments, the sensor reading compared against the upper and lower thresholds can include all or some of the sensor readings from each horticulture automation devices 200 such that a breach occurs when any one of the sensor readings exceeds the upper threshold or drops below the lower threshold. In some embodiments, the algorithm can be set to send an alert (e.g., texts, indicators on a screen, sounds, lights, haptic signals, emails) to a user when either the upper or lower threshold is breached. In some embodiments, the algorithm can be set to instruct actions when two or more thresholds are breached.

FIG. 6 is a front view of a luminaire panel system 601 installed on a frame structure of a horticulture grow rack system 600 in accordance with embodiments of the present technology. The luminal panel system 601 can include a plurality of luminaire panels 630 and one or more spine members 612 having a channel or other lumen through which wires 604 (e.g., for power, connectivity) can extend to electrically connect to the luminaire panels 630 via, for example, connection ports 622. In some embodiments, the wires 604 connect the luminaire panel system 601 to the horticulture automation devices 200 described above. The system 601 is suspended from the existing frame structure of the horticulture grow rack system 600. For example, the individual luminaire panels 630 and/or the spine 612 can be secured to the existing vertical supports 603 (shown extending perpendicular to the plane of the page), side support beams 605, and/or cross-beams 607 extending between the side support beams 605 of the vertical grow rack 600 to secure the wire harnessed luminaire panel system 601 above a grow tray. In the illustrated embodiment, the luminaire panels 630 are attached to the cross-beams 607, though the panels 630 may alternately or additionally be attached to the vertical supports 603 and/or the side supports 605.

In the illustrated embodiment, the luminaire panel system 600 includes two luminaire panel assemblies 632 (identified individually as a first luminaire panel assembly 1032a and a second luminaire panel assembly 1032b), each having ten luminaire panels 630, with five panels 630 positioned on each side of the spine 612, and wires 604 extending from the spine 612 to each panel 630. In some embodiments, each luminaire panel assembly 632 can have fewer than or more than ten luminaire panels 630 and/or the luminaire panel assemblies 632 along each grow rack level (e.g., shelf) can have different numbers of luminaire panels 630. In some embodiments, a single luminaire panel assembly 632 can extend across an entire grow rack shelf or more than two luminaire panel assemblies 632 can be used on a single level. The luminaire panels 630 of each luminaire panel assembly 632 can be electrically connected in series or in parallel. In some embodiments, the luminaire panels 630 can be wired such that the panels 630 of each assembly 632 are controlled together (e.g., from a single channel 208 of the horticulture automation device 200). In some embodiments, each panel 630 or subsets of the panels 630 can be electrically coupled separately (e.g., to different channels 208 of the horticulture automation device 200) such that individual or groups of panels 630 can be controlled independently of each other.

The spine member 612 of each luminaire panel assembly 632 have a channel through which the wires 604 extend. The wires 604 can be waterproofed (e.g., jacketed, coated, surrounded in rubber, plastic, or other material) to withstand indoor grow environments. The spine 612 can be an elongate, tubular structure composed of plastic, metal, or other suitable materials for supporting the wires 604. In some embodiments, the spine 612 can have a different shape depending on the configuration of the luminaire panels 630. In some embodiments, the spine 630 can support additional devices or features, such as sensors or cameras, and/or electrical wires associated therewith.

As shown in FIG. 6, the horticulture grow rack system 600 includes vertical supports 603 at each of the four corners, the side support beams 605 connecting the vertical supports 603, and multiple cross beams 607 extending across the side support beams 605 at a generally perpendicular angle. In some embodiments, the horticulture grow rack system 600 can include additional side support beams 605, cross beams 607, and/or vertical supports 603. The cross beams 607 can be secured to a bottom lip areas of opposing side support beams 605 via fasteners, welding, interfacing surfaces, and/or other coupling mechanisms. The vertical supports 603, the side support beams 607, and the cross beams 605 can be composed of metal (e.g., steel), plastic, and/or other suitable materials for supporting grow decks, associated irrigation, and the luminaire panel system 601. The vertical supports 603, side support beams 605 and/or the cross beams 607 can be part of a standard shelving unit and the luminaire panel assemblies 632 can be attached or suspended therefrom using the already existing structure of the standard shelving, and thereby allowing the luminaire panel assemblies 632 to conveniently fit into existing grow decks and standardized shelving structures.

In the illustrated embodiment, the luminaire panels 630 are arranged in two rows such that each luminaire panel 630 is mounted to one cross beam 607, each cross beam 607 supports two luminaire panels 630, and the spine 612 is optionally mounted to one or more cross beams 607 between the two rows of panels 630. As described in further detail below, the luminaire panels 630 can be attached to the cross beams 607 using various different attachment mechanisms, such as braces, connector knobs, interfacing surfaces, screws, and/or other fastening mechanisms. In some embodiments, the luminaire panels 630 and the spines 612 can be arranged in a different configuration.

In some embodiments, each luminaire panel assembly 632 may cover a four feet (1.22 m) by four feet (1.22 m) area. For example, the two assemblies 632 illustrated in FIG. 6 may cover a four feet (1.22 m) by eight feet (2.44 m) area. In some embodiments, the luminaire panel assembly 632 can be configured to extend across a larger or smaller area, such as by changing the dimensions of each luminaire panel 630, increasing or decreasing the number of luminaire panels 630, changing the spacing between the cross beams 607, and/or orienting each luminaire panel 630 in a different direction. In some embodiments, the luminaire panel system 601 can include a luminaire panel system as described in U.S. patent application Ser. No. 18/318,706, entitled HORTICULTURE LUMINAIRE SYSTEM, DEVICES, AND METHODS, filed May 16, 2023, and which is incorporated by reference in its entirety.

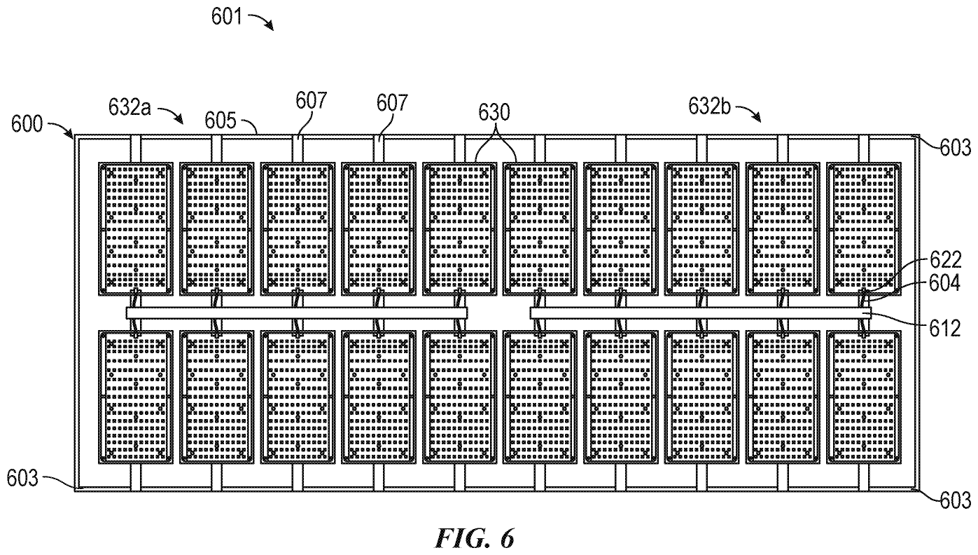

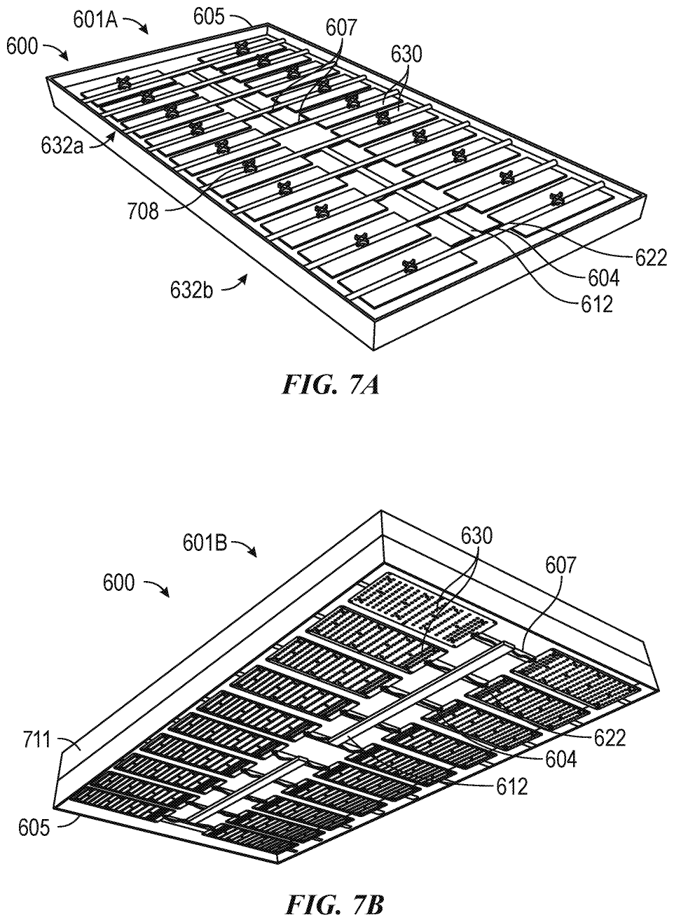

FIG. 7A is an isometric top view of the luminaire panel system 601A of FIG. 6 installed on an upper or top layer of the horticulture grow rack system 600 (partially shown) in accordance with embodiments of the present technology. Each luminaire panel 630 is releasably mounted to a single cross beam 607 via a releasable fastener 708. For example, in the embodiment illustrated in FIG. 7A, the releasable fasteners 708 are adjustable knobs. The cross beams 607 can include T-slot channels or other structures configured to receive the releasable fasteners 708. In some embodiments, the releasable fastener 708 can be used to adjust and affix the angle of each luminaire panel 630 relative to an underlying grow tray (not shown), thereby controlling the lighting conditions of the grow tray positioned below the luminaire panel system 601A. In other embodiments, the panels 630 can be mounted to the cross beams 607 via other mechanisms (e.g., magnets, screws, interfacing surfaces, nuts and bolts, clips). The spine 612 can be attached to lower sides (i.e., the underside) of one or more cross beams 607 (as shown), attached to upper sides of one or more cross beams 607, hang from the luminaire panels 630 below the cross beams 607 via the wires 604, or rest atop one or more cross beams 607. The wires 604 can extend through the spine 612 and either above or below the cross beams 607 to electrically connect to the individual luminaire panels 630.

In some embodiments, the luminaire panel system 601A is installed on existing frame of side support beams 605 (i.e., the outer peripheral beams defining the periphery of a shelf, referred to as a “shelf support frame”) already existing on a vertical grow rack. The cross beams 607 be added to the shelf support frame and the luminaire panel assemblies 632 can be attached thereto, allowing the user to dictate the position of the cross beams 607 based on the desired position of the luminaire panels 630. In some embodiments, the shelf support frame already includes the cross beams 607 and the luminaire panels 630 can be attached thereto. In some embodiments, the luminaire panel system 601A includes the side support beams 605 and the cross beams 607, such that the entire structure (e.g., shown in FIG. 7A) can be attached to vertical supports of the grow rack at a desired height and position relative to the underlying grow tray via screws, welding, interfacing surfaces, and/or other attachment mechanisms. In this manner, the system 601A is like a cassette or fully formed shelf that can be easily installed on vertical supports.

FIG. 7B is an isometric bottom view of the luminaire panel system 601B of FIG. 6 for an intermediate layer of the vertical grow rack in accordance with embodiments of the present technology. The luminaire panel system 601B includes features similar to those described above with respect to FIG. 7A, such as the connection to the cross beams 607. However, because the luminaire panel system 600B is for an intermediate layer of the vertical grow rack of the horticulture grow rack system 600, a grow tray 711 is coupled to and/or stacked on an upper side of the side support beams 605 (i.e., the side nearest the back side of the luminaire panels 630). The grow tray 711 can house or otherwise receive the soil, seeds, bulbs, plants, and/or related materials for growing plants in an indoor environment. The luminaire panel system 601B illustrated in FIG. 7B can be used to provide lighting to a grow tray (not shown) positioned below the luminaire panel system 601B, while the grow tray 711 can receive lighting from another luminaire panel system 601B positioned above the grow tray 711. In some embodiments, the vertical grow rack of the horticulture grow rack system 600 can include additional layers between the side support beams 605 and the grow tray 711, such as an irrigation system, a nutrient managing system, a ventilation system, and/or other systems for supporting an indoor growing environment.

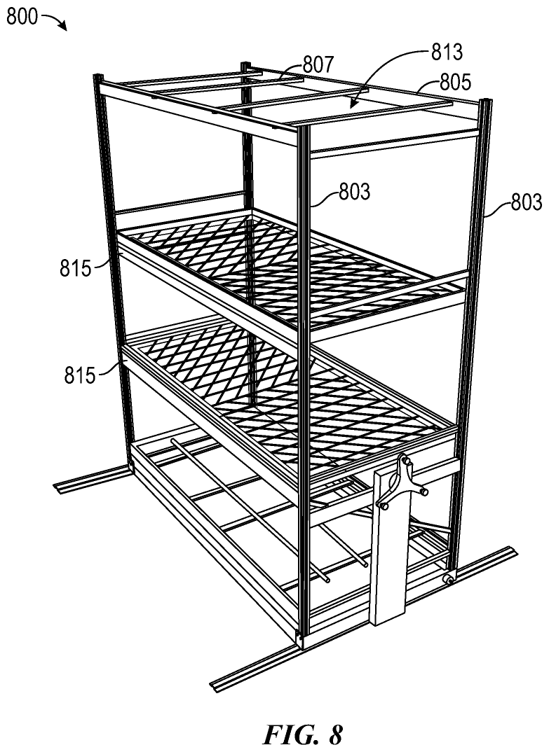

FIG. 8 is an isometric view of a horticulture grow rack system 800 configured to receive luminaire panel assemblies in in accordance with embodiments of the present technology. Similar to the horticulture grow rack system described above, the horticulture grow rack system 800 includes vertical supports 803, side support beams 805 extending between the vertical supports 803, and cross members 807 extending between opposing side support beams 805. The luminaire panel system 601A of FIG. 7A can be positioned on the top level 813 of the horticulture grow rack system 800 as described above with respect to FIGS. 6 and 7A, and one or more of the luminaire panel systems 601B of FIG. 7B can be poisoned on the intermediate shelves 815 to provide lighting to an underlying grow tray and, optionally, a grow tray that receives light from an overlying luminaire panel system 601. In some embodiments, the horticulture grow rack system 800 includes the luminaire panel system 601A, 601B positioned as modular units (e.g., referred to as “cassettes”) between the four vertical supports 803 at desired heights. Accordingly, the frameless luminaire panel systems and assemblies can provide modular, easy to install units that can utilize existing vertical grow rack frames (or portions thereof) to create a customizable, yet efficient to install system. In some embodiments, the horticulture grow rack system 800 can include other horticulture devices as described above with respect to FIG. 4.

Any one of the proceeding embodiments and or features thereof can be combined with any of the other embodiments disclosed herein (or portions thereof),

### Further Examples

The following examples are illustrative of several embodiments of the present technology:

1. A horticulture automation device, comprising:
a sensor input configured to receive sensor readings related to a horticulture environment;
an internet of things (“IoT”) module operably coupled to the sensor input, wherein the IoT module is configured to communicate the sensor readings to a database and receive instructions to manage the horticulture environment;
a plurality of power supply channels configured to be electrically coupled to a power supply, wherein the power channels are configured to transfer and distribute power from the power supply to luminaire panels coupled to the power supply channels;
a power control unit operatively coupled to the IoT module and the plurality of power channels, wherein the power control unit is configured to control transfer and distribution of the power from the power supply to the power supply channels, thereby controlling operation of the luminaire panels; and
a housing carrying the sensor input, the plurality of power channels, the IoT module, and the power control unit, wherein the housing is configured to be positioned at a vertical grow rack.

2. The device of example 1 wherein the instructions comprise:
upon determining that one of the sensor readings reaches a first predetermined threshold, alter the transfer and distribution of power to at least one of the power supply channels until the one of the sensor readings reaches a second predetermined threshold.

3. The device of any one of the preceding examples wherein the sensor readings comprise a humidity reading, a temperature reading, a carbon dioxide level reading, a lighting level reading, and/or a grow media moisture reading.

4. The device of any one of the preceding examples wherein the sensor readings comprise one or more of a grow media pH level reading, a nutrient concentration reading, and/or an electrical conductivity reading.

5. The device of any one of the preceding examples, further comprising:
a power over ethernet (PoE) module electrically coupled to the IoT module, wherein the PoE is configured to supply power to the IoT module.

6. The device of any one of the preceding examples wherein the IoT module is configured to send instructions to control horticulture equipment, wherein the horticulture equipment comprises an HVAC system, an irrigation system, and/or a fertilization system.

7. The device of any one of the preceding examples, further comprising a plurality of status lights carried by the housing and visible external to the housing, wherein the plurality of status lights are configured to indicate an operational status of the one or more horticulture equipment coupled to the channels.

8. A horticulture automation system, comprising:
a horticulture deck supporting a horticulture environment, the horticulture deck comprising—
   a plurality of sensors configured to collect sensor readings related to the horticulture environment;
   a plurality of horticulture devices coupled to the horticulture deck, wherein the horticulture equipment are configured to manage the horticulture environment, and wherein the horticulture equipment comprises luminaire panels; and
a horticulture automation device coupled to the horticulture deck, comprising—
   a sensor input operably coupled to the plurality of sensors and configured to receive the sensor readings from the sensors;
   an IoT module operably coupled to the sensor input, wherein the IoT module is configured to communicate the sensor readings to a database and receive instructions to manage the horticulture environment;
   a plurality of power supply channels configured to be electrically coupled to a power supply, wherein the power channels are configured to transfer and distribute power from the power supply to luminaire panels coupled to the power supply channels; and
   a power control unit operatively coupled to the IoT module and the plurality of power supply channels, wherein the power control unit is configured to control transfer and distribution of the power from the power supply to the power supply channels, thereby controlling operation of the luminaire panels.

9. The system of any one of the preceding examples, wherein the horticulture automation device is one of a plurality of horticulture automation devices, wherein the system is configured to group the horticulture automation devices into a first group and a second group based on positions of the devices relative to the horticulture environment, and wherein the instructions to manage the horticulture environment are configured to be sent to the first group or the second group.

10. The system of example 9, wherein the instructions comprise:
upon determining that an average value of sensor readings from sensors coupled to horticulture automation devices in the first group reached a first predetermined threshold, alter the transfer and distribution of power to the channels of the horticulture automation devices in the first group until the average value reaches a second predetermined threshold.

11. The system of any one of the preceding examples, wherein the instructions comprise:
upon determining that one of the sensor readings reached a first predetermined threshold, alter the transfer and distribution of power to one of the power supply channels until the one of the sensor readings reaches a second predetermined threshold.

12. The system of any one of the preceding examples, wherein the horticulture deck comprises a grow tray, and wherein the horticulture devices are arranged vertically extending from a back side of the grow tray.

13. The system of any one of the preceding examples, further comprising:
a vertical grow rack assembly including support beams; and
a plurality of the horticulture decks coupled to the support beams and arranged in a vertical manner such that the horticulture decks define separate levels of the vertical grow rack assembly.

14. The system of any one of the preceding examples, wherein the IoT module is configured to send an alert to a user device upon determining that one of the sensor readings reached a predetermined threshold.

15. The system of any one of the preceding examples, wherein the database is configured to generate and send to a user device a financial report relating to the horticulture environment.

16. The system of any one of the preceding examples, wherein the sensors comprise one or more of a humidity sensor, a temperature sensor, a carbon dioxide level sensor, a lighting level sensor, and a grow media moisture sensor.

17. The system of any one of the preceding examples, wherein the sensors comprise one or more of a grow media pH level sensor, a nutrient concentration sensor, and an electrical conductivity sensor.

18. The system of any one of the preceding examples, wherein the plurality of horticulture devices further comprise an HVAC system, an irrigation system, and/or a fertilization system.

19. A method of operating a horticulture automation system, comprising:
coupling a plurality of sensors, a plurality of horticulture equipment, and a horticulture automation device to a horticulture deck supporting a horticulture environment;
configuring the horticulture automation device to collect sensors readings relating to the horticulture environment from the sensors;
configuring an IoT module of the horticulture automation device to communicate the collected sensor readings to a database;
instructing the IoT module to manage the horticulture environment; and
configuring a power control unit of the horticulture automation device to control transfer and distribution of power from a power supply to a plurality of channels of the horticulture automation device, thereby controlling operation of the horticulture equipment.

20. The method of any one of the preceding examples, wherein configuring the power control unit comprises, upon determining that one of the sensor readings reaches a first predetermined threshold, altering the transfer and distribution of power to the channels until the one of the sensor readings reaches a second predetermined threshold.

21. The method of any one of the preceding examples, wherein the horticulture automation device is a first horticulture automation device, the method further comprising—
coupling a second horticulture automation device to the horticulture deck.

22. The method of any one of the preceding examples, further comprising configuring the IoT module to send an alert to a user device upon determining that one of the sensor readings reached a predetermined threshold.

### CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “or” as in “A or B” refers to A alone, B alone, and both A and B, unless the context specifically shows otherwise. Additionally, the terms “comprising,” “including,” “having,” and “with” are used throughout to mean including at least the recited feature(s) such that any greater number of the same features or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A horticulture automation device, comprising:
a sensor input configured to receive sensor readings related to a horticulture environment;
an internet of things (“IoT”) module operably coupled to the sensor input, wherein the IoT module is configured to communicate the sensor readings to a database and receive instructions to manage the horticulture environment;
a plurality of power supply channels configured to be electrically coupled to a power supply, wherein the power channels are configured to transfer and distribute power from the power supply to luminaire panels coupled to the power supply channels;
a power control unit operatively coupled to the IoT module and the plurality of power channels, wherein the power control unit is configured to control transfer and distribution of the power from the power supply to the power supply channels, thereby controlling operation of the luminaire panels; and
a housing carrying the sensor input, the plurality of power channels, the IoT module, and the power control unit, wherein the housing is configured to be positioned at a vertical grow rack.

2. The device of claim 1 wherein the instructions comprise:
upon determining that one of the sensor readings reaches a first predetermined threshold, alter the transfer and distribution of power to at least one of the power supply channels until the one of the sensor readings reaches a second predetermined threshold.

3. The device of claim 1 wherein the sensor readings comprise a humidity reading, a temperature reading, a carbon dioxide level reading, a lighting level reading, and/or a grow media moisture reading.

4. The device of claim 1 wherein the sensor readings comprise one or more of a grow media pH level reading, a nutrient concentration reading, and/or an electrical conductivity reading.

5. The device of claim 1, further comprising:
a power over ethernet (PoE) module electrically coupled to the IoT module, wherein the PoE is configured to supply power to the IoT module.

6. The device of claim 1 wherein the IoT module is configured to send instructions to control horticulture equipment, wherein the horticulture equipment comprises an HVAC system, an irrigation system, and/or a fertilization system.

7. The device of claim 1, further comprising a plurality of status lights carried by the housing and visible external to the housing, wherein the plurality of status lights are configured to indicate an operational status of the one or more horticulture equipment coupled to the channels.

8. A horticulture automation system, comprising:
a horticulture deck supporting a horticulture environment, the horticulture deck comprising—
a plurality of sensors configured to collect sensor readings related to the horticulture environment;
a plurality of horticulture devices coupled to the horticulture deck, wherein the horticulture equipment are configured to manage the horticulture environment, and wherein the horticulture equipment comprises luminaire panels; and
a horticulture automation device coupled to the horticulture deck, comprising—
a sensor input operably coupled to the plurality of sensors and configured to receive the sensor readings from the sensors;
an IoT module operably coupled to the sensor input, wherein the IoT module is configured to communicate the sensor readings to a database and receive instructions to manage the horticulture environment;
a plurality of power supply channels configured to be electrically coupled to a power supply, wherein the power channels are configured to transfer and distribute power from the power supply to luminaire panels coupled to the power supply channels; and
a power control unit operatively coupled to the IoT module and the plurality of power supply channels, wherein the power control unit is configured to control transfer and distribution of the power from the power supply to the power supply channels, thereby controlling operation of the luminaire panels.

9. The system of claim 8, wherein the horticulture automation device is one of a plurality of horticulture automation devices, wherein the system is configured to group the horticulture automation devices into a first group and a second group based on positions of the devices relative to the horticulture environment, and wherein the instructions to manage the horticulture environment are configured to be sent to the first group or the second group.

10. The system of claim 9, wherein the instructions comprise:
upon determining that an average value of sensor readings from sensors coupled to horticulture automation devices in the first group reached a first predetermined threshold, alter the transfer and distribution of power to the channels of the horticulture automation devices in the first group until the average value reaches a second predetermined threshold.

11. The system of claim 8, wherein the instructions comprise:
upon determining that one of the sensor readings reached a first predetermined threshold, alter the transfer and distribution of power to one of the power supply channels until the one of the sensor readings reaches a second predetermined threshold.

12. The system of claim 8, wherein the horticulture deck comprises a grow tray, and wherein the horticulture devices are arranged vertically extending from a back side of the grow tray.

13. The system of claim 8, further comprising:
a vertical grow rack assembly including support beams; and
a plurality of the horticulture decks coupled to the support beams and arranged in a vertical manner such that the horticulture decks define separate levels of the vertical grow rack assembly.

14. The system of claim 8, wherein the IoT module is configured to send an alert to a user device upon determining that one of the sensor readings reached a predetermined threshold.

15. The system of claim 8, wherein the database is configured to generate and send to a user device a financial report relating to the horticulture environment.

16. The system of claim 8, wherein the sensors comprise one or more of a humidity sensor, a temperature sensor, a carbon dioxide level sensor, a lighting level sensor, and a grow media moisture sensor.

17. The system of claim 8, wherein the sensors comprise one or more of a grow media pH level sensor, a nutrient concentration sensor, and an electrical conductivity sensor.

18. The system of claim 8, wherein the plurality of horticulture devices further comprise an HVAC system, an irrigation system, and/or a fertilization system.

19. A method of operating a horticulture automation system, comprising:
coupling a plurality of sensors, a plurality of horticulture equipment, and a horticulture automation device to a horticulture deck supporting a horticulture environment;
configuring the horticulture automation device to collect sensors readings relating to the horticulture environment from the sensors;
configuring an IoT module of the horticulture automation device to communicate the collected sensor readings to a database;
instructing the IoT module to manage the horticulture environment; and
configuring a power control unit of the horticulture automation device to control transfer and distribution of power from a power supply to a plurality of channels of the horticulture automation device, thereby controlling operation of the horticulture equipment.

20. The method of claim 19, wherein configuring the power control unit comprises, upon determining that one of the sensor readings reaches a first predetermined threshold, altering the transfer and distribution of power to the channels until the one of the sensor readings reaches a second predetermined threshold.

21. The method of claim 19, wherein the horticulture automation device is a first horticulture automation device, the method further comprising—
coupling a second horticulture automation device to the horticulture deck.

22. The method of claim 19, further comprising configuring the IoT module to send an alert to a user device upon determining that one of the sensor readings reached a predetermined threshold.
